(19) United States
(12) Patent Application Publication
(10) Pub. No.: US 2009/0207299 A1
(43) Pub. Date: Aug. 20, 2009

(54) ELECTRONIC CAMERA

(75) Inventor: Takahiro HORI, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Osaka (JP)

(21) Appl. No.: 12/369,047

(22) Filed: Feb. 11, 2009

(30) Foreign Application Priority Data
Feb. 16, 2008 (JP) 2008-035376

(51) Int. Cl. H04N 5/232

(52) U.S. Cl. 348/349; 348/E05.041

(57) ABSTRACT

An electronic camera includes an imaging device. The imaging device has an imaging surface capturing an object scene through a focus lens and repeatedly produces an object scene image. The focus lens is moved in an optical-axis direction in parallel with a process of the imaging device. A high-frequency component of the object scene image is extracted by a focus evaluation circuit in parallel with moving of the focus lens. A CPU specifies lens positions respectively corresponding to local maximum values found from the extracted high-frequency component. When an interval ΔF between the specified lens positions falls below a threshold value, the focus lens is placed at a lens position on the nearest side, out of the specified lens positions. When the interval ΔF is equal to or more than the threshold value, the focus lens is placed at a position different from the lens position on the nearest side.

### CROSS REFERENCE OF RELATED APPLICATION

The disclosure of Japanese Patent Application No. 2008-35376, which was filed on Feb. 16, 2008 is incorporated herein by reference.

### BACKGROUND OF THE INVENTION

1. Field of the Invention

The present invention relates to an electronic camera. More particularly, the present invention relates to an electronic camera that adjusts a distance from a focus lens to an imaging surface based on an object scene image produced in the imaging surface.

2. Description of the Related Art

According to one example of this type of a camera, when the luminance of an object is equal to or less than a predetermined luminance level, and a focus evaluation value increases towards an endpoint, search control is executed in which a plurality of focus evaluation values are obtained by moving the focus lens within a predetermined drive range including the endpoint Thereby, it becomes surely possible to determine whether or not the increase in the focus evaluation value in the vicinity of the endpoint is caused due to an external turbulence. However, the above-described camera poses a problem in that when a local maximum value of the focus evaluation value is detected in the vicinity of the endpoint regardless of a focal state by photographing an object with low illumination, low contrast, or of a point light source, etc., the focus lens is set in a wrong position.

### SUMMARY OF THE INVENTION

An electronic camera according to the present invention, comprises: an imager for repeatedly producing an object scene image, the imager having an imaging surface irradiated with an optical image of an object scene through a lens; a mover for moving the lens in an optical-axis direction in parallel with an image producing process of the imager; an extractor for extracting a high-frequency component of the object scene image produced by the imager in parallel with a moving process of the mover, a specifier for specifying a plurality of lens positions respectively corresponding to a plurality of local maximum values found from the high-frequency component extracted by the extractor, a first placer for placing the lens at a lens position on the nearest side, out of the plurality of lens positions specified by the specifier, when an interval between lens positions at both edges, out of the plurality of lens positions specified by the specifier, falls below a threshold value; and a second placer for placing the lens at a position different from the lens position on the nearest side, when the interval between lens positions at both edges, out of the plurality of lens positions specified by the specifier, is equal to or more than the threshold value.

Preferably, the specifier includes: a first lens-position specifier for specifying a lens position equivalent to a maximum value of a first high-frequency component belonging to a first area on the imaging surface, out of the high-frequency component extracted by the extractor; and a second lens-position specifier for specifying a lens position equivalent to a maximum value of a second high-frequency component belonging to a second area on the imaging surface, out of the high-frequency component extracted by the extractor, and each of the first placer and the second placer notices an interval between the two lens positions specified by the first lens-position specifier and the second lens-position specifier, respectively.

Preferably, the first area is larger than the second area, and the second placer places the lens at the lens position specified by the first lens-position specifier.

Preferably, the second placer places the lens at a predetermined position.

Preferably, the second placer places the lens at a lens position on the farthest infinity side, out of the plurality of lens positions specified by the specifier.

According to the present invention, an imaging control program product executed by a processor of an electronic camera, the electronic camera including: an imager for repeatedly producing an object scene image, the imager having an imaging surface irradiated with an optical image of an object scene through a lens; a mover for moving the lens in an optical-axis direction in parallel with an image producing process of the imager; and an extractor for extracting a high-frequency component of the object scene image produced by the imager in parallel with a moving process of the mover, the imaging control program product, comprises: a specifying step of specifying a plurality of lens positions respectively corresponding to a plurality of local maximum values found from the high-frequency component extracted by the extractor; a first placing step of placing the lens at a lens position on the nearest side, out of the plurality of lens positions specified in the specifying step, when an interval between lens positions at both edges, out of the plurality of lens positions specified in the specifying step, falls below a threshold value; and a second placing step of placing the lens at a position different from the lens position on the nearest side, when the interval between lens positions at both edges, out of the plurality of lens positions specified in the specifying step, is equal to or more than the threshold value.

According to the present invention, an imaging control method executed by an electronic camera, the electronic camera including: an imager for repeatedly producing an object scene image, the imager having an imaging surface irradiated with an optical image of an object scene through a lens; a mover for moving the lens in an optical-axis direction in parallel with an image producing process of the imager, and an extractor for extracting a high-frequency component of the object scene image produced by the imager in parallel with a moving process of the mover, the image control method, comprises: a specifying step of specifying a plurality of lens positions respectively corresponding to a plurality of local maximum values found from the high-frequency component extracted by the extractor; a first placing step of placing the lens at a lens position on the nearest side, out of the plurality of lens positions specified in the specifying step, when an interval between lens positions at both edges, out of the plurality of lens positions specified in the specifying step, falls below a threshold value; and a second placing step of placing the lens at a position different from the lens position on the nearest side, when the interval between lens positions at both edges, out of the plurality of lens positions specified in the specifying step, is equal to or more than the threshold value.

An electronic camera according to the present invention, comprises: an imager for repeatedly producing an object scene image, the imager having an imaging surface irradiated with an optical image of an object scene through a lens; a mover for moving the lens in an optical-axis direction in parallel with an image producing process of the imager; an extractor for extracting a high-frequency component of the object scene image produced by the imager in parallel with a moving process of the mover, a specifier for specifying a plurality of lens positions respectively corresponding to a plurality of local maximum values found from the high-frequency component extracted by the extractor, a first placer for placing the lens at any one of the plurality of lens positions specified by the specifier, when an interval between lens positions at both edges, out of the plurality of lens positions specified by the specifier, falls below a threshold value; and a second placer for placing the lens at a position different from any one of the plurality of lens positions specified by the specifier, when the interval between lens positions at both edges, out of the plurality of lens positions specified by the specifier, is equal to or more than the threshold value.

The above described features and advantages of the present invention will become more apparent from the following detailed description of the embodiment when taken in conjunction with the accompanying drawings.

### BRIEF DESCRIPTION OF THE DRAWINGS

FIG. 1 is a block diagram showing a configuration of one embodiment of the present invention;

FIG. 2 is an illustrative view showing one example of an allocation state of an evaluation area in an imaging surface;

FIG. 3 is an illustrative view showing one example of a configuration of a register applied to the embodiment in FIG. 1;

FIG. 4 is a block diagram showing one example of a configuration of a luminance evaluation circuit applied to the embodiment in FIG. 1;

FIG. 5 is a block diagram showing one example of a configuration of a focus evaluation circuit applied to the embodiment in FIG. 1;

FIG. 6 is a graph showing one example of an operation of an AF process;

FIG. 7 is a flowchart showing one portion of an operation of a CPU applied to the embodiment in FIG. 1;

FIG. 8 is a flowchart showing another portion of the operation of the CPU applied to the embodiment in FIG. 1;

FIG. 9 is a flowchart showing still another portion of the operation of the CPU applied to the embodiment in FIG. 1;

FIG. 10 is a flowchart showing one portion of an operation of a CPU applied to another embodiment;

FIG. 11 is a flowchart showing one portion of an operation of a CPU applied to still another embodiment; and

FIG. 12 is a flowchart showing one portion of an operation of a CPU applied to a yet still another embodiment.

### DETAILED DESCRIPTION OF THE PREFERRED EMBODIMENTS

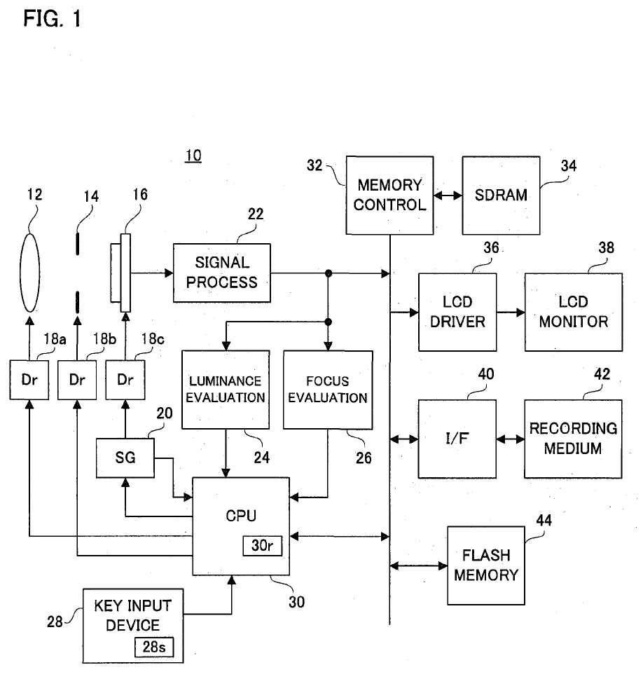

With reference to FIG. 1, a digital camera 10 according to this embodiment includes a focus lens 12 and an aperture unit 14. The focus lens 12 and the aperture unit 14 are driven by drivers 18a and 18b, respectively. An optical image of an object scene undergoes the focus lens 12 and the aperture unit 14, is irradiated onto an imaging surface of an imaging device 16, and is subjected to photoelectric conversion. Thereby, electric charges representing an object scene image are produced.

When a power supply is turned on, a CPU 30 commands a driver 18c to repeatedly perform a pre-exposure operation and a thinning-out reading-out operation in order to execute a through-image process. The driver 18c performs the pre-exposure on the imaging surface and also reads out the electric charges produced on the imaging surface in a thinning-out manner, in response to a vertical synchronization signal Vsync generated at every 1/30 seconds from an SG (Signal Generator) 20. Low-resolution raw image data based on the read-out electric charges is cyclically outputted from the imaging device 16 in a raster scanning manner.

A signal processing circuit 22 performs processes, such as white balance adjustment, color separation, and YUV conversion, on the raw image data outputted from the imaging device 16, and writes the image data of a YUV format created thereby into an SDRAM 34 through a memory control circuit 32. An LCD driver 36 repeatedly reads out the image data written in the SDRAM 34 through the memory control circuit 32, and drives an LCD monitor 38 based on the read-out image data. As a result, a real-time moving image (through image) of the object scene is displayed on a monitor screen.

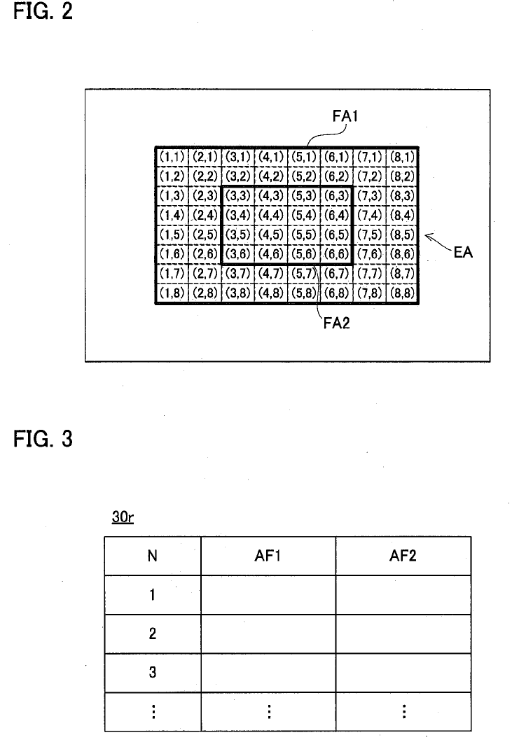

With reference to FIG. 2, an evaluation area EA is allocated to the imaging surface. The evaluation area EA is divided into eight in each of a vertical direction and a horizontal direction, and is formed by a total of 64 partial evaluation areas. To these 64 partial evaluation areas, coordinate values (X, Y)=(1, 1) to (8, 8) are respectively allocated.

A luminance evaluation circuit 24 integrates, at every 1/30 seconds, Y data belonging to each partial evaluation area out of Y data outputted from the signal processing circuit 22, and outputs 64 integrated values Iy (1, 1) to Iy (8, 8) respectively corresponding to the 64 partial evaluation areas (1, 1) to (8, 8). The CPU 30 repeatedly executes an AE process for a through image (a simple AE process) in parallel with the above-described through image process in order to calculate an appropriate EV value based on the integrated values. An aperture amount and an exposure time which define the calculated appropriate EV value are set to the driver 18b and driver 18c. As a result, the brightness of the moving image outputted from the LCD monitor 38 is adjusted moderately.

When a shutter button 28s on a key input device 28 is half-depressed, a strict AE process for recording is executed in order to calculate the optimal EV value based on the integrated values outputted from the luminance evaluation circuit 24. Similar to the case described above, an aperture amount and an exposure time which define the calculated optimal EV value are set to the driver 18b and driver 18c, respectively.

Upon completion of the AE process for recording, an AF process based on output of a focus evaluation circuit 26 is executed. The focus evaluation circuit 26 integrates, at every 1/30 seconds, a high-frequency component of the Y data belonging to each partial evaluation area out of the Y data outputted from the signal processing circuit 22, and outputs the 64 integrated values Iyh (1, 1) to Iyh (8, 8) respectively corresponding to the above-described 64 partial evaluation areas (1, 1) to (8, 8). The CPU 28 fetches these integrated values from the focus evaluation circuit 26, and searches a focal point by a so-called hill-climbing process. The focus lens 12 moves stepwise in an optical-axis direction each time the vertical synchronization signal Vsync is generated, and is placed at the detected focal point.

When the shutter button 28s is fully depressed, a recording process is executed. The CPU 30 commands the driver 18c to execute a main exposure operation and all-pixel reading-out, one time each. The driver 18c performs the main exposure on the imaging surface in response to the generation of the vertical synchronization signal Vsync, and reads out all the electric charges produced in the imaging surface in a raster scanning manner. As a result, high-resolution raw image data representing an object scene is outputted from the imaging device 16.

The outputted raw image data is subjected to a process similar to that described above, and as a result, high-resolution image data according to a YUV format is secured in the SDRAM 34. An I/F 40 reads out the high-resolution image data thus accommodated in the SDRAM 34 through the memory control circuit 32, and then, records the read-out image data on a recording medium 42 in a file format. It is noted that the through-image process is resumed at a time point when the high-resolution image data is accommodated in the SDRAM 34.

In association with the AF process, the CPU 30 defines the evaluation area EA shown in FIG. 2 as a focus area FA1, and at the same time, defines 16 partial evaluation areas (3, 3) to (6, 6) present in the center of the evaluation area EA as a focus area FA2, and moves stepwise the focus lens 12 from a near-side end to an infinity-side end, through the driver 18a. It is noted that each time the focus lens 12 moves by one stage, a variable N is incremented.

Each time the vertical synchronization signal Vsync is generated, the CPU 30 obtains a total sum of the 64 integrated values Iyh (1, 1) to Iyh (8, 8) corresponding to the focus area FA1 as a focus evaluation value AF1, and obtains a total sum of the 16 integrated values Iyh (3, 3) to Iyh (6, 6) corresponding to the focus area FA2 as a focus evaluation value AF2. The obtained focus evaluation values AF1 and AF2 are set forth in a register 3Or shown in FIG. 3 in association with a current value of the variable N.

When the focus lens 12 reaches the infinity-side end, the CPU 30 detects a maximum value from a plurality of focus evaluation values AF1s set forth in the register 30r, and defines a lens position corresponding to the detected maximum value as a local maximum point LM1. The CPU 30 also detects a maximum value from a plurality of focus evaluation values AF2s set forth in the register 30r, and defines a lens position corresponding to the detected maximum value as a local maximum point LM2.

Thereafter, the CPU 30 calculates an interval between the local maximum points LM1 and LM2 as ΔL, and compares the calculated interval ΔL with a threshold value Ls. When the interval ΔL falls below the threshold value Ls, the CPU 30 considers a local maximum point on a near side, out of the local maximum points LM1 and LM2, as the focal point, and places the focus lens 12 at this focal point. In contrast to this, when the interval ΔL is equal to or more than the threshold value Ls, the CPU 30 considers a predetermined point DP1 (a point focused at a distance of 2 meters from the imaging surface) as the focal point, and places the focus lens 12 at this focal point.

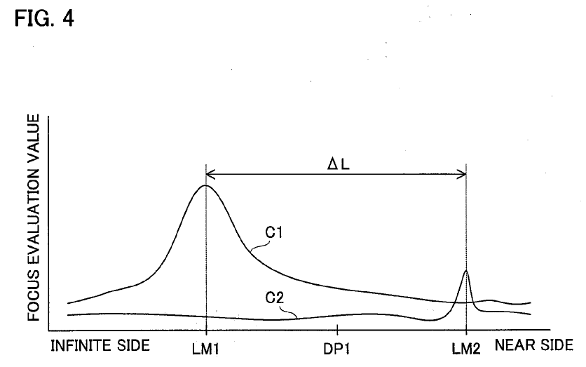

When the focus evaluation values AF1 and AF2 change along curves C1 and C2 shown in FIG. 4, respectively, the local maximum point LM1 is detected from the vicinity of the infinity edge and the local maximum point LM2 is detected from the vicinity of the near edge, and the interval between the local maximum points LM1 and LM2 is calculated as ΔL. When the interval ΔL falls below the threshold value Ls, the local maximum point LM2 is assumed to be the focal point, and when the interval ΔL is equal to or more than the threshold value Ls, the predetermined point DP1 is assumed to be the focal point.

That is, when the interval ΔL is adequate, both of the local maximum points LM1 and LM2 are considered equivalent to the focal point, and the focus lens 12 is placed at the local maximum point on the nearest side. In contrast to this, when the interval ΔL is too wide, either of the local maximum points LM1 and LM2 is considered equivalent to a pseudo focal point, and the focus lens 12 is placed at a predetermined point DP1 different from the local maximum point on the nearest side. Thereby, it becomes possible to improve a focal performance at the time of photographing an object with low illumination, low contrast, or of a point light source, etc.

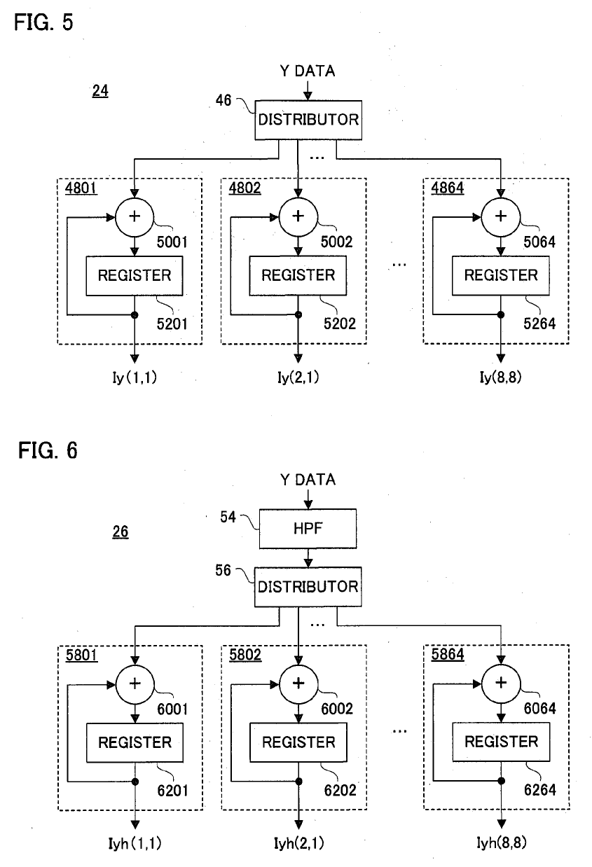

The luminance evaluation circuit 24 is configured as shown in FIG. 5. The Y data applied from the signal processing circuit 22 is applied to a distributor 46. The integration circuits 4801 to 4864 correspond to the 64 partial evaluation areas (1, 1) to (8, 8), respectively. A distributor 102 specifies the partial evaluation area to which the applied Y data belongs, and then, inputs the Y data to the integration circuit corresponding to the specified partial evaluation area.

The integration circuit 48** (**:01 to 64) is formed by an adder 50** and a register 52**. The adder 50** adds a Y data value applied from the distributor 46 to a setting value of the register 52**, and sets the added value to the register 52**. The setting value of the register 52** is cleared each time the vertical synchronization signal Vsync is generated. Therefore, the setting value of the register 52** represents an integrated value of the Y data belonging to each partial evaluation area of a current frame.

The focus evaluation circuit 26 is configured as shown in FIG. 6. An HPF 54 extracts a high-frequency component of the Y data applied from the signal processing circuit 22. The integration circuits 5801 to 5864 correspond to the above-described 64 partial evaluation areas (1, 1) to (8, 8), respectively.

The distributor 56 fetches the high-frequency component extracted by the HPF 54, specifies the partial evaluation area to which the fetched high-frequency component belongs, and applies the fetched high-frequency component to the integration circuit corresponding to the specified partial evaluation area.

The integration circuit 58** is formed by an adder 60** and a register 62**. The adder 60** adds a high-frequency component value applied from the distributor 56 to a setting value of the register 62**, and sets the added value to the register 62**. The setting value of the register 62** is cleared each time the vertical synchronization signal Vsync is generated. Therefore, the setting value of the register 62** represents an integrated value of the high-frequency component of the Y data belonging to each partial evaluation area of a current frame.

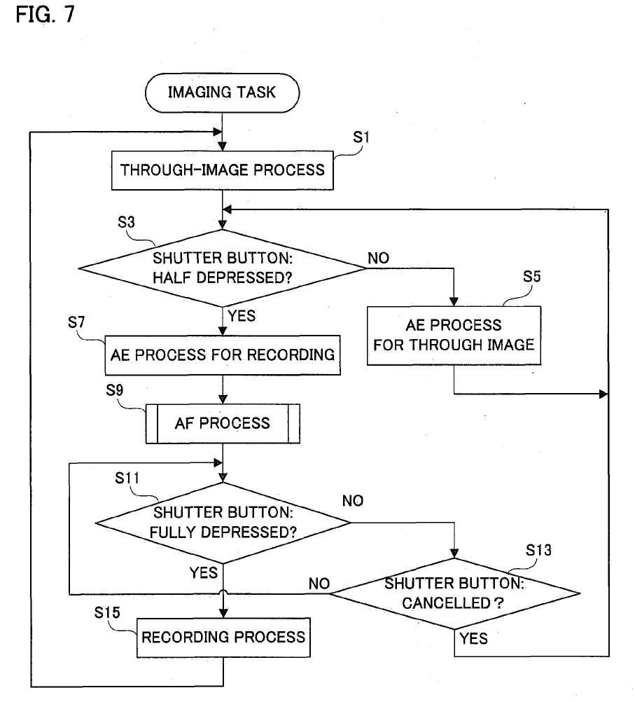

The CPU 30 executes a process according to an imaging task shown in FIG. 7 to FIG. 9. It is noted that a control program corresponding to the imaging task is stored in a flash memory 44.

Firstly, the through-image process is executed in a step S1. As a result, the through image that represents the object scene is outputted from the LCD monitor 38. In a step S3, it is determined whether or not the shutter button 28s is half-depressed, and as long as the determination result indicates NO, the AE process for a through image in a step S5 is repeated. As a result, the brightness of the through image is adjusted moderately. When the shutter button 28s is half-depressed, the AE process for recording is executed in a step S7, and the AF process is executed in a step S9. By the AE process for recording, the brightness of the through image is adjusted to the optimal value, and by the AF process, the focus lens 12 is placed at the focal point.

In a step S11, it is determined whether or not the shutter button 28s is fully depressed, and in a step S13, it is determined whether or not the operation of the shutter button 28s is cancelled. When YES is determined in the step S11, the process returns to the step S1 via the recording process in a step S15. When YES is determined in a step S13, the process returns to the step S3 as it is.

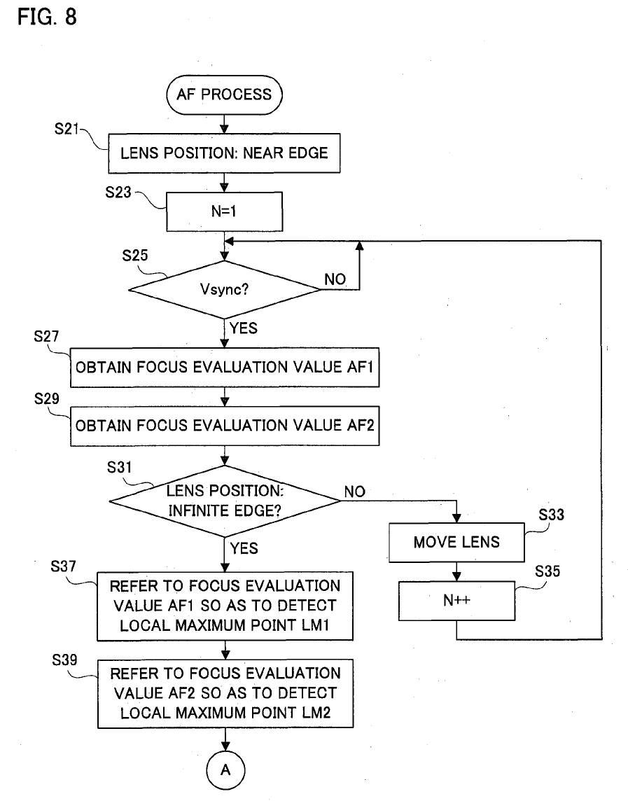

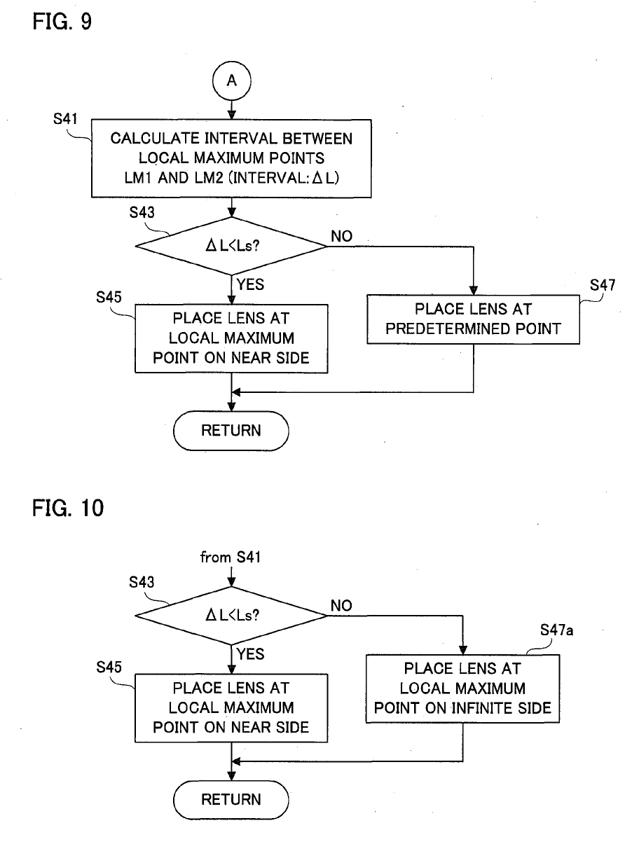

The AF process in the step S9 is executed according to a sub-routine shown in FIG. 8 to FIG. 9. Firstly, in a step S21, the focus lens 12 is placed at the nearer side end. In a step S23, the variable N is set to “1”, the process proceeds from a step S25 to a step S27 after waiting for the generation of the vertical synchronization signal Vsync. In the step S27, the integrated values Iyh (1, 1) to Iyh (8, 8) are fetched from the focus evaluation circuit 26, and the focus evaluation value AF1 corresponding to the focus area FA1 shown in FIG. 2 is obtained. In a step S29, the focus evaluation value AF2 corresponding to the focus area FA2 shown in FIG. 2 is obtained. The obtained focus evaluation values AF1 and AF2 are set forth in a column corresponding to the variable N in the register 30r shown in FIG. 3.

In a step S31, it is determined whether or not the focus lens 12 reaches the infinity-side end, and when YES is determined, the process proceeds to processes from a step S37 onwards. In contrast to this, when NO is determined, the focus lens 12 is moved by one stage towards the infinity side in a step S33, the variable N is incremented in a step S35, and thereafter, the process returns to the step S25.

In the step S37, the maximum value is specified from among the plurality of focus evaluation values AF1s set to the register 30r, and a lens position corresponding to the specified maximum value is detected as the local maximum point LM1. In a step S39, a maximum value is specified from among the plurality of focus evaluation values AF2s set to the register 30r, and a lens position corresponding to the specified maximum value is detected as the local maximum point LM2. In a step S41, the interval between the local maximum points LM1 and LM2 thus detected is calculated as ΔL. In a step S43, it is determined whether or not the calculated interval ΔL falls below the threshold value Ls.

When the interval ΔL falls below the threshold value Ls, the process proceeds from the step S43 to a step S45, and when the interval ΔL is equal to or more than the threshold value Ls, the process proceeds from the step S43 to a step S47. In the step S45, out of the local maximum points LM1 and LM2, the local maximum point of the near side is considered as the focal point, and the focus lens 12 is placed on this focal point. In the step S47, the predetermined point DP1 is considered as the focal point, and the focus lens 12 is placed at this focal point. Upon completion of the process in the step S45 or S47, the process is restored to the routine of the upper hierarchical level.

As seen from the above description, the imaging device 16 has an imaging surface irradiated with an optical image of an object scene that undergoes the focus lens 12, and repeatedly produces an object scene image. The focus lens 12 is moved in an optical-axis direction by the driver 18a, in parallel with the image-producing process of the imaging device 16. The high-frequency component of the object scene image produced by the imaging device 16 is extracted by the focus evaluation circuit 26, in parallel with the moving process of the focus lens 12. The CPU 30 specifies a plurality of lens positions respectively corresponding to a plurality of local maximum values (the maximum value out of the focus evaluation values AF1s and the maximum value out of the focus evaluation values AF2s) found from the extracted high-frequency component (S27, S29, S37, and S39). When the interval (=ΔL) between a plurality of specified lens positions falls below the threshold value Ls, the CPU 30 places the focus lens 12 at the lens position on the nearest side, out of the plurality of specified lens positions (S45). Furthermore, when the interval ΔL is equal to or more than the threshold value Ls, the CPU 30 places the focus lens 12 at a mined position different from the lens position on the nearest side (S47).

That is, when the interval between a plurality of lens positions respectively corresponding to a plurality of local maximum values is adequate, all of the lens positions are considered equivalent to the focal point. In this case, the focus lens 12 is placed at the lens position on the nearest side. In contrast to this, when the interval between a plurality of lens positions respectively corresponding to a plurality of local maximum values is too wide, any one of the lens positions is considered equivalent to the pseudo focal point. In this case, the focus lens 12 is placed at a position different from the lens position on the nearest side. Thereby, it becomes possible to improve the focal performance at the time of photographing an object with low illumination, low contrast, or of a point light source, etc.

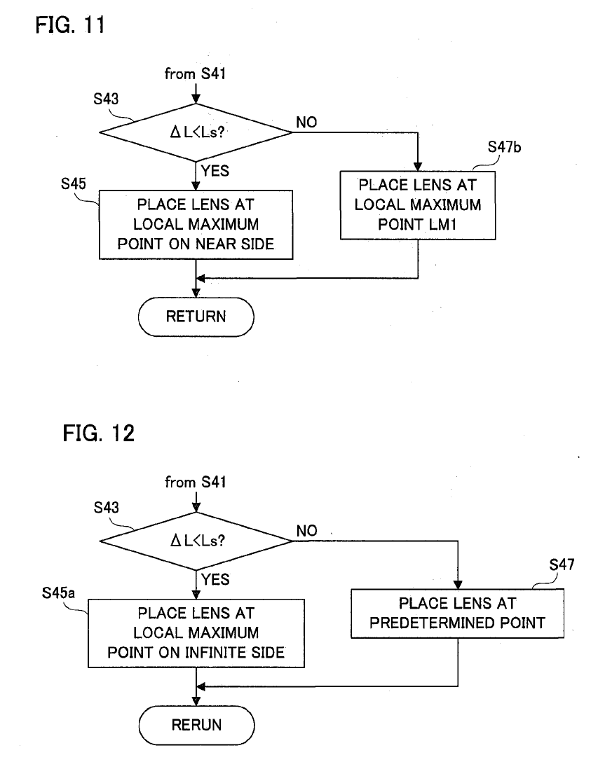

It is noted that in this embodiment, when the interval ΔL is equal to or more than the threshold value Ls, the focus lens 12 is placed at the predetermined point DP1 different from the detected local maximum point. Instead thereof, the focus lens 12 may also be placed at the local maximum point on the infinite side or the local maximum point LM1. However, in the case of the former, there is a need of executing a process in a step S47a shown in FIG. 10 in place of the process in the step S47 shown in FIG. 9, and in the case of the latter, there is a need of executing a process in a step S47b shown in FIG. 11 in place of the process in the step S47 shown in FIG. 9.

The reason for noticing the local maximum point LM1 rather than the local maximum point LA2 in the step S47b is that the focus area FA1 corresponding to the local maximum point LM1 is larger than the focus area FA2 corresponding to the local maximum point LM2, and the reliability of the focus evaluation value AF1 is higher than that of the focus evaluation value AF2.

Furthermore, in this embodiment, when the interval ΔL falls below the threshold value Ls, the focus lens 12 is placed at the local maximum point on the near side. Instead thereof, the focus lens 12 may also be placed at the local maximum point on the infinite side, which is another local maximum point In this case, there is a need of executing process in a step S45a shown in FIG. 12 in place of the process in the step S47 shown in FIG. 9.

Also, in this embodiment, the focus lens 12 is moved in an optical-axis direction in order to adjust the focus. However, together with the focus lens 12 or instead of the focus lens 12, the imaging device 16 may also be moved in an optical-axis direction.

Furthermore, in this embodiment, it is attempted to find the two local maximum values from the high-frequency component. However, three or more local maximum values may also be found from the high-frequency component.

It is noted that as the nature of an optical mechanism, a relationship between the lens position and the object distance changes due to a temperature characteristic or other factors, which results in a deviation in the position on the optical mechanism that defines a focusing-enabled design range (distance from near to infinite). Therefore, normally in the optical mechanism, a range wider (extended range) than the focusing enabled design range is prepared, so that the focusing enabled design range can be shifted within this extended range.

In this embodiment, a scanning operation is performed throughout the entire extended range by utilizing the structure of such an optical mechanism. Thus, when the interval between the local maximum points at both ends out of a plurality of local maximum points specified by the scanning operation is too wider than the focusing-enabled design range, at least one local maximum point is determined as the pseudo focal point. Therefore, the threshold value Ls is equivalent to the length of the focusing-enabled design range.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An electronic camera, comprising:
an imager for repeatedly producing an object scene image, said imager having an imaging surface irradiated with an optical image of an object scene through a lens;
a mover for moving said lens in an optical-axis direction in parallel with an image producing process of said imager;
an extractor for extracting a high-frequency component of the object scene image produced by said imager in parallel with a moving process of said mover;
a specifier for specifying a plurality of lens positions respectively corresponding to a plurality of local maximum values found from the high-frequency component extracted by said extractor;
a first placer for placing said lens at a lens position on the nearest side, out of the plurality of lens positions specified by said specifier, when an interval between lens positions at both edges, out of the plurality of lens positions specified by said specifier, falls below a threshold value; and
a second placer for placing said lens at a position different from the lens position on the nearest side, when the interval between lens positions at both edges, out of the plurality of lens positions specified by said specifier, is equal to or more than the threshold value.

2. An electronic camera according to claim 1, wherein said specifier includes: a first lens-position specifier for specifying a lens position equivalent to a maximum value of a first high-frequency component belonging to a first area on said imaging surface, out of the high-frequency component extracted by said extractor, and a second lens-position specifier for specifying a lens position equivalent to a maximum value of a second high-frequency component belonging to a second area on said imaging surface, out of the high-frequency component extracted by said extractor, and
each of said first placer and said second placer notices an interval between the two lens positions specified by said first lens-position specifier and said second lens-position specifier, respectively.

3. An electronic camera according to claim 1, wherein the first area is larger than the second area, and the second placer places said lens at the lens position specified by said first lens-position specifier.

4. An electronic camera according to claim 1, wherein said second placer places said lens at a predetermined position.

5. An electronic camera according to claim 1, wherein said second placer places said lens at a lens position on the farthest infinity side, out of the plurality of lens positions specified by said specifier.

6. An imaging control program product executed by a processor of an electronic camera, said electronic camera including:
an imager for repeatedly producing an object scene image, said imager having an imaging surface irradiated with an optical image of an object scene through a lens;
a mover for moving said lens in an optical-axis direction in parallel with an image producing process of said imager; and
an extractor for extracting a high-frequency component of the object scene image produced by said imager in parallel with a moving process of said mover, said imaging control program product, comprising:
a specifying step of specifying a plurality of lens positions respectively corresponding to a plurality of local maximum values found from the high-frequency component extracted by said extractor;
a first placing step of placing said lens at a lens position on the nearest side, out of the plurality of lens positions specified in said specifying step, when an interval between lens positions at both edges, out of the plurality of lens positions specified in said specifying step, falls below a threshold value; and
a second placing step of placing said lens at a position different from the lens position on the nearest side, when the interval between lens positions at both edges, out of the plurality of lens positions specified in said specifying step, is equal to or more than the threshold value.

7. An imaging control method executed by an electronic camera, said electronic camera including:
an imager for repeatedly producing an object scene image, said imager having an imaging surface irradiated with an optical image of an object scene through a lens;
a mover for moving said lens in an optical-axis direction in parallel with an image producing process of said imager; and
an extractor for extracting a high-frequency component of the object scene image produced by said imager in parallel with a moving process of said mover, said imaging control method, comprising:
a specifying step of specifying a plurality of lens positions respectively corresponding to a plurality of local maximum values found from the high-frequency component extracted by said extractor;
a first placing step of placing said lens at a lens position on the nearest side, out of the plurality of lens positions specified in said specifying step, when an interval between lens positions at both edges, out of the plurality of lens positions specified in said specifying step, falls below a threshold value; and
a second placing step of placing said lens at a position different from the lens position on the nearest side, when the interval between lens positions at both edges, out of the plurality of lens positions specified in said specifying step, is equal to or more than the threshold value.

8. An electronic camera, comprising:
an imager for repeatedly producing an object scene image, said imager having an imaging surface irradiated with an optical image of an object scene through a lens;
a mover for moving said lens in an optical-axis direction in parallel with an image producing process of said imager;
an extractor for extracting a high-frequency component of the object scene image produced by said imager in parallel with a moving process of said mover;
a specifier for specifying a plurality of lens positions respectively corresponding to a plurality of local maximum values found from the high-frequency component extracted by said extractor;
a first placer for placing said lens at any one of the plurality of lens positions specified by said specifier, when an interval between lens positions at both edges, out of the plurality of lens positions specified by said specifier, falls below a threshold value; and
a second placer for placing said lens at a position different from any one of the plurality of lens positions specified by said specifier, when the interval between lens positions at both edges, out of the plurality of lens positions specified by said specifier, is equal to or more than the threshold value.
